(19) United States
(12) Patent Application Publication
(10) Pub. No.: US 2023/0252505 A1
(43) Pub. Date: Aug. 10, 2023

(54) PRESENTATION MANAGEMENT OF ENTERPRISE INFORMATION

(71) Applicant: Hironobu KATOH, Tokyo (JP)

(72) Inventor: Hironobu KATOH, Tokyo (JP)

(21) Appl. No.: 18/302,912

(22) Filed: Apr. 19, 2023

Related U.S. Application Data
(63) Continuation-in-part of application No. 16/488,519, filed on Aug. 23, 2019.

(51) Int. Cl. G06Q 30/0202; G06Q 10/04

(52) U.S. Cl. CPC G06Q 30/0202; G06Q 10/04

(57) ABSTRACT

A presentation management system and method for presenting business performance information of an enterprise that includes a server configured to receive from a plurality of client terminals a business forecast value for the enterprise, validate an integrity of plurality of users sending the business forecast value, anonymize the business forecast value and store, in the memory, the anonymized business forecast value, calculate and/or update, in an automated manner, a market forecast value for the enterprise based on a plurality of the stored business forecast values, transmit an alert message, receive a request from the at least one client terminal to receive the market forecast value, and transmit the market forecast value for displaying on the at least one client terminal. The server is further configured to calculate and/or update and display the calculated market forecast value based on user selected parameters received from the at least one client terminal.

### CROSS-REFERENCE TO RELATED APPLICATION

This application is a continuation-in-part of U.S. application Ser. No. 16/488,519, filed Aug. 23, 2019, which is a national stage entry of international application PCT/JP2017/038367, filed Oct. 24, 2017, which are incorporated by reference.

The present technology relates to a system and a method to manage presentation of business information, such as, performance or business forecast values of enterprises, on a client terminal that provides a unique and meaningful visual representation of the business information to each user for quick and efficient analysis and user interaction.

### BACKGROUND

Prior methods and systems are used to present certain types of business information to a user, but are deficient in that the methods and systems have limited adaptability, for example, user selection of data for analysis and display, do not have high data integrity, do not provide anonymity, and do not have adequate functions for presenting the business information to the user for quick action by the user.

For example, a method for recommending stocks (issue) purchasing and selling of an enterprise is mainly considered to be as follows.

1) Determined based on stocks' market prices.

For example, a sell recommendation is made when an absolute stock price is too high, and a buy recommendation is made when the absolute stock price is too low. In addition, a sell recommendation is made when an increase in a stock price during a certain period is too large, and a buy recommendation is made when a decrease in the stock price is too large.

2) Determined based on market capitalization.

For example, a buy recommendation is made when a market capitalization is lower than those of similar enterprises. In addition, a buy recommendation is made for small market capitalization stocks with large upside in absolute value. For a large cap stock having a large absolute market capitalization, a sell recommendation is made when there is little room for increase.

3) Determined based on forecasts made by analysts of securities companies or research companies.

Whether a stock price is high or low is determined based on business performance forecasts of analysts. For example, a buy recommendation is made according to an analyst in charge of an electrical appliances sector when a stock price or market capitalization of company A is low with respect to the business performance of company A.

Surprises are forecasted based on a business performance forecast of a specific analyst. For example, a specific analyst B forecasts that business performance of company A exceeds consensus of an unspecified number of analysts collected by Nikkei QUICK Inc., Bloomberg, securities companies, research companies, and the like, and makes a buy recommendation.

4) Determined Based on Basket Recommendation

An unspecified number of issues that are included in a specific theme or sector are recommended. For example, since artificial intelligence (AI) will be developed in the future, it is recommended to purchase stocks of 30 AI-related companies.

In addition, an unspecified number of issues are recommended, which are extracted based on certain indices or factors, such as a dividend payout ratio and a return on equity (ROE). For example, it is recommended to purchase issues having high dividend yields. However, determination is made based on forecasts of securities companies and research companies, or each listed company's plans or actual performance.

As such, the business information presented to a user is difficult to interpret and view, especially, when a large number of business, e.g., over 100 companies, report business information, such as earnings, at the same time. Moreover, since the earnings report in conjunction with the recommendations for stocks (issue) purchasing and selling of an enterprise is numerous and computationally intensive, the prior methods and systems do not provide an adequate interface for buying and/or selling stocks of the enterprise in a quick and efficient manner. Furthermore, the methods and systems are not configured to maintain anonymity of the user and are not configured to have a high data integrity for the business information that is presented.

### SUMMARY

Features in the embodiments disclosed herein are at least directed to methods and systems for presenting business information to a user that is based on user selected parameters such that the user may make informed and quick decisions based on the presented business information that provides quick and efficient analysis and user action/interaction. The methods and systems may also provide improvements over existing methods and systems by providing anonymity of the users, maintaining high data integrity of the business information, providing relevant business information to the user, and/or increasing speed of displaying the business information to the user.

In an example embodiment, a presentation management system for presenting business performance information of an enterprise on at least one client terminal is provided. The presentation management system includes a server that includes a processor and a memory. The server is configured to receive from a plurality of client terminals a business forecast value for the enterprise from a plurality of users, validate an integrity of the plurality of users sending the business forecast value from the plurality of client terminals, anonymize the business forecast value from each of the plurality of users and the plurality of client terminals transmitting the associated business forecast value and store, in the memory, the anonymized business forecast value, calculate and/or update, in an automated manner, a market forecast value for the enterprise based on a plurality of the stored business forecast values, transmit an alert message to the at least one client terminal, wherein the alert message indicates that a deviation value with regard to a business forecast value from the at least one client terminal from the market forecast value is greater than a predetermined value, receive a request from the at least one client terminal to receive the market forecast value, and transmit the market forecast value for displaying on the at least one client terminal. The server is also configured to calculate and/or update and transmit the calculated market forecast value based on user selected parameters received from the at least one client terminal.

In another example embodiment, a presentation management method is provided. The presentation management method includes receiving on a server, from a plurality of client terminals, a business forecast value for an enterprise from a plurality of users; validating, on the server, an integrity of the plurality of users sending the business forecast value from the plurality of client terminals; anonymizing, by the server, the business forecast value from each of the plurality of users and the plurality of client terminals transmitting the associated business forecast value and storing, in memory on the server, the anonymized business forecast value; calculating and/or updating, in an automated manner on the server, a market forecast value for the enterprise based on a plurality of the stored business forecast values; transmitting an alert message to at least one client terminal, wherein the alert message indicates that a deviation value with regard to a business forecast value from the at least one client terminal from the market forecast value is greater than a predetermined value; receiving a request from at least one client terminal to receive the market forecast value; transmitting the market forecast value for displaying on the at least one client terminal; and displaying on the at least one client terminal the transmitted market forecast value. The method may have the calculating and/or updating and displaying of the market forecast value to include adjusting and/or displaying the calculated market forecast value based on user selected parameters received from the at least one client terminal.

In yet another example embodiment, a presentation management system for presenting business performance information of an enterprise on at least one client terminal is provided. The presentation management system includes a means for receiving, from a plurality of client terminals, a business forecast value for the enterprise from a plurality of users; a means for validating an integrity of the plurality of users sending the business forecast value from the plurality of client terminals; a means for anonymizing the business forecast value from each of the plurality of users and the plurality of client terminals transmitting the associated business forecast value and a means for storing the anonymized business forecast value; a means for calculating and/or updating, in an automated manner, a market forecast value for the enterprise based on a plurality of the stored business forecast values; a means for transmitting an alert message to the at least one client terminal, wherein the alert message indicates that a deviation value with regard to a business forecast value from the at least one client terminal from the market forecast value is greater than a predetermined value; a means for receiving a request from the at least one client terminal to receive the market forecast value; a means for transmitting the market forecast value for displaying on the at least one client terminal; and a means for displaying the transmitted market forecast value. The means for calculating and/or updating and the means for displaying the market forecast value are configured to adjust the market forecast value based on user selected parameters received from the at least one client terminal.

In another example embodiment, a business performance forecast management system may be provided. The business performance management system is configured to manage business performance forecast of an enterprise. The system may include a server, which includes a processor and a memory; and a plurality of client terminals, which are capable of communicating with the server. Each of the client terminals is configured to transmit, to the server, a respective business forecast value related to business performance of the enterprise. The server is configured to store, in the memory, the business forecast value received from each of the client terminals, calculate a market forecast value based on the plurality of the stored user business forecast values, calculate a deviation value of the business forecast value transmitted from at least one of the client terminals with respect to the market forecast value, and transmit an alert to the at least one client terminal when the deviation value is equal to or greater than a predetermined value. Such a system may allow the user to make recommendations according to views of each user based on the user's own business forecast values, who may be a stock market participant, instead of being based on business forecast values from securities companies, or research institutions or forecasts of third parties. The recommendations may be based on an average and distribution of business forecast values of system's participants; changes in an average of business forecast values of system participants; and may be recommendations whether to hold stocks long-term based on business forecast values rather than stock prices or recommendations whether a user should take action based on that a selected user's performance.

### BRIEF DESCRIPTION OF DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Non-limiting and non-exhaustive descriptions are described with reference to the following drawings. The components in the figures are not necessarily to scale, emphasis instead being placed upon illustrating principles. In the detailed description that follows, embodiments are described as illustrations only since various changes and modifications may become apparent to those skilled in the art from the following detailed description.

FIG. 1 illustrates an example presentation management system in accordance with at least some embodiment described herein.

FIG. 2 illustrates a graphical user interface that may be implemented in accordance with at least some embodiments described herein.

FIG. 3 illustrates a histogram that may be used with a graphical user interface that may be implemented in accordance with at least some embodiments described herein.

FIG. 4 illustrates a graphical user interface that may be implemented in accordance with at least some other embodiments described herein.

FIG. 5 illustrates a graphical user interface that may be implemented in accordance with at least some other embodiments described herein.

FIG. 6 illustrates a graphical user interface that may be implemented in accordance with at least some others embodiments described herein.

FIG. 7 illustrates a flowchart of a presentation management method in accordance with at least some embodiment described herein.

FIG. 8 is a schematic structural diagram of an example computer system applicable to implementing an electronic device, arranged in accordance with at least some embodiments described herein.

### DETAILED DESCRIPTION

In the following detailed description, particular embodiments of the present disclosure are described herein with reference to the accompanying drawings, which form a part of the description. In this description, as well as in the drawings, like-referenced numbers represent elements that may perform the same, similar, or equivalent functions, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Additionally, the present disclosure may be described herein in terms of functional block components and various processing steps. It should be appreciated that such functional blocks may be realized by any number of hardware and/or software components configured to perform the specified functions.

The scope of the disclosure should be determined by the appended claims and their legal equivalents, rather than by the examples given herein. For example, the steps recited in any method claims may be executed in any order and are not limited to the order presented in the claims. Moreover, no element is essential to the practice of the disclosure unless specifically described herein as “critical” or “essential”.

Features in the embodiments disclosed herein are at least directed to methods and systems for presenting user selected business information to a user based on user selected parameters in a unique and meaningful visual representation such that the user may make informed and quick decisions based on the presented business information that provides quick and efficient analysis and user action/interaction. The methods and systems may also provide improvements over existing methods and systems by providing anonymity of the users, maintaining high data integrity of the business information, providing relevant business information to the user, and/or increasing speed of displaying the business information to the user.

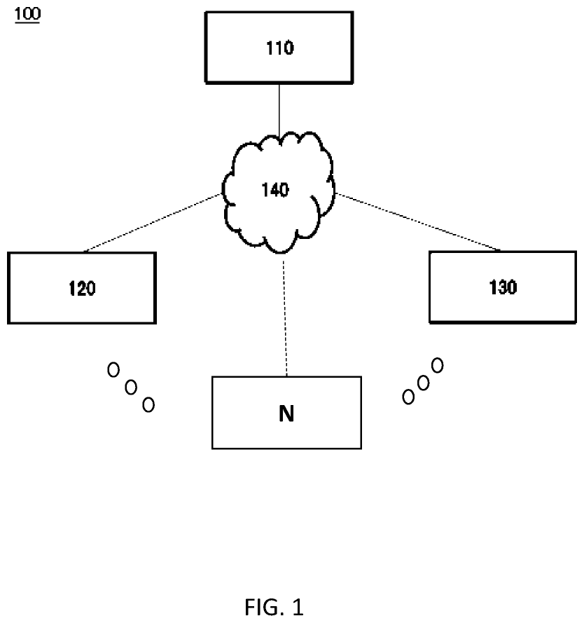

FIG. 1 is an illustration of a presentation management system 100 to present business performance information of an enterprise according to an example embodiment. The presentation management system 100 includes a server 110 connected to the Internet 140 and a plurality of client terminals, e.g., 120, 130, . . . n.

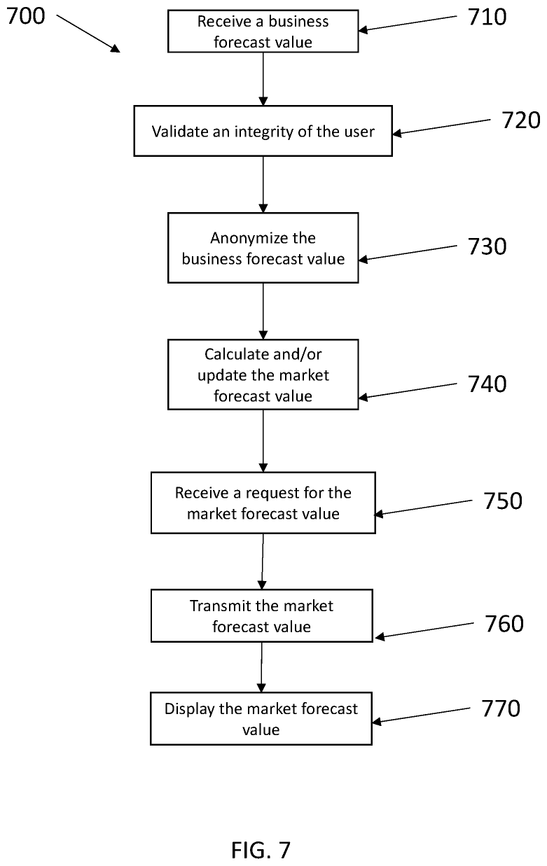

The server 110 may be a computer that includes a processor and memory (e.g., as shown in FIG. 7) or cloud-based server that may be configured to communicate with the plurality of client terminals 120, 130, . . . , N via the Internet 140. The plurality of client terminals 120, 130, . . . , N may be a computer, a tablet terminal, a smartphone, or other processor enabled device (e.g., as shown in FIG. 7) that is configured to communicate with the server 110 via the Internet 140. The plurality of client terminals is not limited to the client terminal 120, the client terminal 130, and may include any number of client terminals that may be connected to the server 110.

The server 110 and/or client terminal 120, 130, . . . N may be configured to perform a number of different processes and/or functions. In an embodiment, the server 110 may be configured to receive business forecast values from a plurality of users, validate an integrity of a user sending the business forecast values for each of the plurality of client terminals, anonymize the business forecast values, calculate and/or update market forecast values for enterprises, receive a request for the market forecast value, transmit market forecast values, etc. In an embodiment, the server 110 may also be configured to receive user selected parameters from the at least one client terminal to adjust the calculation of and/or update the market forecast values for subsequent display on the client terminal. The user selected parameters may include: selecting a specific user, for example, the most bullish user and/or “friend”, selecting or using the business forecast values from users having an accuracy level above a threshold value, or an affiliation of the users, displaying only when a threshold number of users have provided the business forecast value, most recent number used by the user, average, median, one standard deviation high/low from average (to avoid outliers), etc. While not intending to limit the scope, the term “friend,” as used herein may be a selection by a user of the at least one client terminal to connect with another user, e.g., to follow the connected user and business forecast values, e.g., their predictions.

In an embodiment, the server 110 may be configured to receive or include a means for receiving a business forecast value for an enterprise from a plurality of users and/or the plurality of client terminals 120, 130, . . . , N. The business forecast value may be related to the business performance of the enterprise, in which the enterprise may be a business, such as a company, that is listed on public and/or private exchanges. In an embodiment, the business forecast value may be a forecast value related to a forecasted profit of the enterprise including, but not limited to, at least one of revenues, operating profit, earnings before tax, net profit, or earnings per share of the enterprise, or a combination thereof, e.g., includes at least two of the forecast values. In an embodiment, the forecast value related to the continuous profit of the enterprise may be a factor specified in advance by the enterprise or by an industry to which the enterprise belongs.

In an embodiment, the server 110 may be configured to validate or include a means for validating the integrity of the plurality of users sending the business forecast value for each of the plurality of client terminals 120, 130, . . . , N to ensure the accuracy of the business forecast value. The validating the integrity of the plurality of users may include: tracking the business forecast value from each of the plurality of users for a predetermined period of time, determining the accuracy of the business forecast value from the users, determining a length of time the user has been actively providing business forecast values, verifying a user's company affiliation and/or existence, e.g., verifying that the user has the job indicated on a user profile and/or the company is a real company in existence, verifying that the user is an original and/or single user, e.g., a unique user that does not have multiple accounts, e.g., based on social security numbers, passport numbers, date of births, addresses, or other identifying information, checking the background of the user, e.g., criminal records check based on publicly available data, education, employment, and other activities, or other checks to ensure that the user is not a bad actor, e.g., someone who is just trying to manipulate or game the system. In an embodiment, the server 110 may be configured to only use business forecast values from validated users, e.g., by filtering and only using business forecast values from highly accurate users, e.g., users having an accuracy level above a threshold value, e.g., 85%, 90% or 95%, as compared with a reported business value, and/or from users that have provided business forecast values for a length of time, e.g., 6 months, 1 year, 2 years, 5 years, etc. The server 110 may also be configured to weight the business forecast value based on the integrity of the user, e.g., by a factor of 5 or 10 when calculating the market forecast value. As such, the presentation management system having the server 110 that is configured to validate the integrity of the user may be able to maintain high data integrity of its system by limiting and/or eliminating the bad actors who are attempting to manipulate the system for only their own financial gain, e.g., users who may be inputting inaccurate business forecast values in bad faith, and/or those with relatively inaccurate business forecast values or experience. In an embodiment, the validating the integrity of the user may occur before anonymizing the business forecast value, as discussed further below.

The validating the integrity of the user may further include tracking how and when the user changes any of the business forecast values sent to the server 110. As such, not only does the time tracking of the entered business forecast values allow the server 110 to be configured to filter out or remove old or stale business forecast values, e.g., based on a predetermined time period or amount of time, e.g., if the business forecast value is more than 1 month old, two months old, four months old, etc., the server 110 may be configured to track a user's accuracy level for all business forecast values submitted to the server 110.

In an embodiment, the server 110 may be configured to determine the accuracy level or the high confidence level of a user by analyzing a past performance of the user. In an embodiment, the accuracy level or the high confidence level may be determined by taking the delta or difference of the business forecast values between top user business forecasters, e.g., top 90%, and the user, taking the delta of the business forecast values between the consensus and the user, taking a delta or difference of the business forecast value between the user and the reported business value, taking a statistical analysis of the delta of the business forecast value between the top user forecasters and consensus and/or the delta between the user and the consensus, taking an analysis of when the forecast was made by the user, e.g., the user may be very accurate when forecast is made three weeks before actual reporting by the business or enterprise, but relatively inaccurate three months before the reporting of the actual business information, the user inputted (subjective) confidence level, which may be analyzed over time to determine the actual accuracy of the user. In an embodiment, the server 110 may be configured to track the user's accuracy level for the business forecast values for one or more enterprises for any specific periods of time, e.g., over the last month, over the last quarter, over the last year, over the last five years, over the last ten years, etc. as compared with historical data and results of the reported business value of the enterprise, e.g., company guidances and/or reportings.

In an embodiment, the server 110 may be configured to use the user accuracy of the business forecast values as a condition for viewing other users' business forecast values, e.g., access rights. For example, the server 110 may be configured such that users having a user accuracy of 70% or less may only be able to view other business forecast values from users having the same or lower accuracy score, e.g., 70% or less. Users, however, having a user accuracy of 85% may be able to view other business forecast values from users having the same or lower user accuracy. As such, since a user may only be able to see other users having the same or lower accuracy, such use of accuracy may be a further disincentive for users to purposely input inaccurate forecasts, e.g., bad actors, to instead provide accurate and validating business forecast values. For example, by being only able to view other users with the same or lower accuracy score, such access rights may disincentivize users from purposely putting in inaccurate forecasts to either manipulate the market or for free-rider effect (get consensus without making proper contribution), since only those with strong track record (accurate business forecasts) will be allowed to see other members with similarly solid track record. In an embodiment, the server 110 may be configured to isolate users with relatively accurate forecasts, e.g., greater than 85% accuracy, greater than 90% accuracy, greater than 95% accuracy, and/or configured to share or transmit the user's overall statistics, e.g., accuracy level. Accuracy can be relative performance compared to benchmark or absolute difference.

In an embodiment, the server 110 may be configured to anonymize or include a means for anonymizing the business forecast values, for example, by removing data associated with the business forecast value and the user and/or the client terminal 120, 130, . . . N transmitting the associated business forecast value. In an embodiment, the business forecast value may be anonymized by automatically re-assigning the business forecast values from the plurality of users to a random and unique ID associated with a user that is stored on the server 110, e.g., in memory. That is, in an embodiment, after a user accesses the server 110, e.g., using a user ID and password, and submits a business forecast value, the server 110 may be configured to disassociate the business forecast value from the respective user, e.g., log-in information, and/or the client terminal, e.g., IP address or computer address. The server 110 may then be configured to associate the business forecast value with a separate and unique identification (ID), e.g., scrubs the data such that the data does not provide any identifying information of the user and/or the client terminal, but allows tracking of the same. As such, the server 110 may be configured to process the business forecast value while maintaining the anonymity of the user(s). In an embodiment, the processing may include grouping business forecast values from people in the same industry, people from the same company affiliation, accuracy of the business forecast values for the last month, last quarter, last year, or other incremented timeframe, or similar grouping method. As such, while large fund managers do not typically have to disclose when they want to divest in a business, e.g., based on the business forecast value, such anonymity allows the large fund managers to be enticed to send their business forecast value for enterprises to get more accurate market forecast values for the enterprises, as a whole in general, e.g., based on all market participants, while preventing other users from front-running the institutional investment managers or large money managers before their divestiture.

In an embodiment, the server 110 may be configured to calculate and/or update or include a means for calculating and/or updating market forecast values for enterprises that are received from the users of the plurality of client terminals. In an embodiment, the calculating of the market forecast values for enterprises may include taking a consensus (e.g., mean or average) of the business forecast values from the plurality of users of the plurality of client terminals. In an embodiment, the calculate and/or update of the market forecast values includes averaging the business forecast value from each of the plurality of client terminals, or taking a mean value of the business forecast value from each of the plurality of client terminals.

The calculating the market forecast values may also include only using data from highly accurate users, validated users, users that have used the system for a length of time, e.g., more than 6 months, more than 1 year, more than 2 years, more than 5 years, etc., or other user selected parameters, e.g., a business forecast value from a specific user or group of users, which may be done automatically, e.g., select most bullish friend(s) the user follows. In an embodiment, the calculating the market forecast values may occur when a predetermined number of business forecast values have been received, e.g., if more than 5, 10, 15, 20, or 25 business forecast values are received. In an embodiment, if the predetermined number of forecast values have not been received, the server 110 may be configured to use any existing values of the market forecast value that have been previously stored on the server 110. The calculating the market forecast value may include rounding each business forecast value based on a certain threshold, e.g., rounding or trimming the business forecast value to the nearest one or ten value up or down, e.g., 105 could be rounded down to 100, sorting the business forecast values to a predetermined number of bins, e.g., data bins, and transmitting the business forecast values from the predetermined bins to at least one client terminal. The bins may be related to the user selected parameters, e.g., grouped based on users belonging to the same industry, on accuracy of the user providing the business forecast values, e.g., all business forecast values from users with 90% accuracy. It is appreciated that the rounding or trimming of the value may help to maintain anonymity and increase data integrity when passing on information from server to local terminal(s).

In an embodiment, the server 110 may be configured to update the market forecast value automatically based on user selected parameters and/or automatically subset the market forecast values to provide narrower datasets, e.g., based on the user selected parameters, for quicker and easier processing and/or transmitting. In an embodiment, the overall market forecast values may be divided into subsets selected from at least one of: business forecast values from users from the same company affiliation, users from the top 50% accuracy levels, platform defined subset(s), e.g., paid users versus free users, institutional money managers v. retail investors, students v. non-student adults, etc.

In an embodiment, the server 110 may be configured to update the market forecast value daily, weekly, monthly, or when a predetermined number of business forecast values have been received, e.g., 5, 10, 15, 20, or 25 business forecast values, and/or based on a user selected time, e.g., past 30 days, past 3 months, past 6 months, past year, or past five years, etc. The business information data and/or market forecast values may be stored for quick access to a separate, NoSQL (non-SQL) or SQL database in which the business information data and/or market forecast values are presorted and/or arranged based on the platform defined subsets and/or user selected parameters, e.g., in bins. It is appreciated that when the business information data is stored on the NoSQL database, the server 110 speed may be increased, while still maintaining data integrity and security.

In an embodiment, the server 110 may be configured to or include means to store the business information data and/or market forecast values periodically, e.g., every hour, every day, every week, every month, etc. The stored data may also include: 1) Time to indicate a point in time associated with the data; 2) Calculated consensus; 3) Histogram range of the business forecast values (example: max 170, min 100); 4) Histogram data (number of data in each histogram bin); 5) Each and all forecast data of a specific company at a specific time that is used for the Histogram data.

In an embodiment, the server 110 may be configured to receive or include a means for receiving a request from at least one client terminal to receive the market forecast value. The receiving or means for receiving may be an automatic request that may be requested automatically, e.g., via a triggering event, such as when a new business forecast value or change is made to the business forecast value, or may be a manual request to receive the market forecast value by the user of the at least one client terminal. The request may include user selected parameters, which may include selecting a specific user, for example, based on being the most bullish friend, user accuracy level, user accuracy level based on a certain time frame, e.g., 85% or 90% accuracy in the last six months, etc. In an embodiment, the users may be categorized as being “friends,” e.g., previous connection between users, being within the same user accuracy group, being within the same industry, etc. In an embodiment, the server 110 may be configured to receive a request from at least one client terminal for any of the above business data, including the market forecast value.

In an embodiment, the server 110 may be configured to verify or include a means for verifying whether the client terminal has access rights to the business information data, e.g., the at least one client terminal may only have access rights from a specific point in time, e.g., past six months, in which case, the server 110 is configured to only send data from that specific time (example: user joined network recently and do not have access rights to historical forecasts) or the at least one client terminal may not have access rights to the business information data if the number of user entries does not exceed a threshold, e.g., more than 5 entries, more than 10 entries, more than 20 entries, more than 50 entries, etc. The server 110 may then be configured to send the business data, which the at least one client terminal has access to, to the at least one client terminal. In an embodiment, the server 110 may also be configured to send the user of the at least one client terminal's historical actuals and forecasts to the at least one client terminal. It is appreciated that since the business data may be stored in bins, no personal data is made available to identify the user and associated business forecast value.

In an embodiment, after the server 110 verifies the access rights of the client terminal, the server 110 may be configured to transmit the market forecast value for displaying on the at least one client terminal.

In an embodiment, the server 110 may be configured to send an alert to the at least one client terminal when the deviation value is equal to or greater than a predetermined value. The predetermined value may be a user selected parameter and may be one or two times of the standard deviation, or may be a predetermined ratio (for example, 10% or 15%) with respect to the consensus value. When there is a large change in one time business performance of an enterprise, for example, as for an enterprise whose annual operating profit is typically around 10 billion yen, in a case where an operating profit in the last year is 1 billion yen due to a one time factor, a business performance forecast of the next year may vary greatly. In such a case, normalization or adjustment may be made.

In another embodiment, the server 110 may be configured to send the alert only when past performance of the user is equal to or greater than a certain level, for example, when a difference between a past business forecast value and an actual performance value of the business performance of the enterprise is within a predetermined range, e.g., the reported business value, and may be sent automatically or only after when Internet communications are established to be automatically displayed on the at least one client terminal when Internet connection is established. The predetermined range may include, for example, a case where past business forecast values of respective users with respect to the enterprise are ranked in an order of closeness to the actual reported business value, and the business forecast value is ranked at a high position. In a case where there are business forecast values and actual reported business values of a plurality of years, more recent ranks may be weighted and averaged, or ranks in years when the business performance variation is larger may be weighted and averaged. The averaged ranks may be expressed in quartiles or quintiles.

In yet another embodiment, the server 110 may also be configured to transmit the alert only when confidence in the business forecast value is high. The alert may indicate that there is a certain amount of deviation between a user's business forecast value and the market forecast value related to the enterprise' business performance forecast of the enterprise. This suggests that the market could be surprised if the user's forecast is correct, and the user can expect the stock price to move significantly. The alert may be considered, for example, as a “securities to watch” or a “securities recommended to buy/sell (trade)” or a condition to buy or sell, e.g., automatically trigger the action.

In still yet another embodiment, the server 110 may be configured to store user profiles of the at least one client terminal on the server 110. The user profiles may contain preferences, parameters, accuracy, length, or other user information related to the user of the at least one client terminal. As such, the user may recover the user profile from the server 110.

In an embodiment, the client terminal 120, 130, . . . N may be configured to perform a number of processes and/or functions. In an embodiment, the client terminal 120, 130, . . . N may be configured to send business forecast values for the enterprise from the user to the server 110. In an embodiment, the client terminal 120, 130, . . . N may be configured to request and/or receive business information data from the server 110, including, but not limited to, histogram data, market forecast values, or other business information, etc. In an embodiment, the client terminal 120, 130, . . . N may include a graphical user interface (GUI) that is configured to interact with the client terminal and/or the server 110.

In an example embodiment, the client terminal 120, 130, . . . N may be configured to send business forecast values for the enterprise from the user by accessing the server 110 using unique log-in identification (ID), such as, User ID and passcode, biometrics, multi-factor authentications, push notifications, or the like that may be stored on or otherwise communicated by the server 110 and associated with the respective user. The business forecast value may be related to the business performance of the enterprise, in which the enterprise may be a business, such as a company, that is listed on public and/or private exchanges. In an embodiment, the business forecast value may be a forecast value related to a forecasted profit of the enterprise including, but not limited to, at least one of revenues, operating profit, earnings before tax, net profit, or earnings per share of the enterprise, or a combination thereof, e.g., includes at least two of the forecast values.

In an embodiment, the client terminal 120, 130, . . . N may be configured to locally store the business forecast value calculated or otherwise determined by the user, e.g., on memory. The client terminal 120, 130, . . . N may store the business forecast value for all quarters or until the business forecast value is calculated or otherwise determined for all four quarters for a fiscal year to calculate current fiscal year multiples and/or avoid NIL errors by sending the batched business forecast values at once. In an embodiment, the client terminal 120, 130, . . . N may be configured to send the business forecast value(s) when network connection, e.g., internet connection, is established and/or automatically through an application stored on the client terminal 120, 130 when network connection, e.g., internet connection, is established or otherwise authorized to transmit, e.g., logged-in on the server 110. In an embodiment, the client terminals 120, 130, . . . N may belong to a group of users, e.g., affiliated with the same company, and all business forecast values made by all of the users of the group during a predetermined time frame, e.g., past 24 hours, may be sent as one batch, e.g., at midnight. It is appreciated by sending the batch of business forecast values, the number of iterations may be reduced for processing the business forecast values.

In an embodiment, the client terminal 120, 130, . . . N may include a graphic user interface (GUI) configured to display or include a means for displaying business information, such as, business forecast values, as graphical representations and may include interactive functions for filtering, modifying, and/or re-arranging automatically the business information, e.g., based on user selected parameters. The GUI may be configured to increase usability of the interface by the user, for example, by providing an interactive platform that not only provides accurate and/or relevant information for use by the user but also provides buttons or icons that may provide a quick and easy visualization to make informed and rapid decisions regarding an enterprise or a plurality of enterprises.

In an embodiment, the GUI may include a plurality of icons for increasing the usability of the interface including, but not limited to, a buy button or icon, a sell button or icon, a rearrangement button or icon, a slide bar for reviewing past business information, standard deviation icon to adjust the filtering based on the standard deviation, e.g., one time, two times, or three times the standard deviation, a user selection button or icon for selecting a user selected parameter, including, but not limited to, most bullish “friend,” selecting a user based on user accuracy level, e.g., 80%, 85, or 90% accuracy buttons or icons, selecting a user based on affiliation, etc.

In an embodiment, the GUI may also include a combination of line graphs, e.g., historical actual earnings, and a histogram, e.g., business forecasts including the user's business forecast and other users' business forecasts, for displaying the business information to the user and having interactive functions thereof. It is understood that instead of or in addition to using a histogram, a heatmap may be used in order to see how the range has changed over time, e.g., data visualization to show magnitude of different business forecast values. It is appreciated that the combination of the GUI and the anonymous data from the server 110 has at least the following advantages at least in view of the presentation of the business information to and/or the ability for interaction by the user:

A) Allows displaying business information anonymously;

B) Allows the user to filter out limited number of outliers, e.g., take out 1 or 2 outliers based on the displayed information;

C) Allows the user to filter out by a standard deviation threshold, e.g., take out those that are three standard deviations away from the mean;

D) Allows filtering out by group or ranking, e.g., accuracy;

E) Allows filtering out those that are stale, e.g., business forecast values that have not been updated over the last 4 months;

F) Allows the displaying only above threshold number of users, e.g., if there are less than 5 users making business forecasts, then do not display chart;

G) Allows the overlaying of a share price line graph with a consensus line graph and a consensus histogram to analyze user's track record;

H) Allows the viewing of history (progression) of consensus which may be represented as a line graph, whereas the range and distribution per period is represented in a heatmap;

I) Allows the viewing of the history (progression) of consensus which may be overlayed on top of the historical share price;

J) Allows the user to visually compare his/her business forecast(s) that may also be represented as a line graph, to business forecast(s) of other users for comparison of the same;

K) Allows the visualization of the combination of line graph, sideway histogram, and lines indicating the user's business forecast values and the consensus.

In an embodiment, the client terminal 120, 130, . . . N and/or the GUI may be configured to rearrange a display of market forecast values for a plurality of enterprises on the GUI of the at least one client terminal based on a magnitude of a deviation value of the business forecast value from a user, e.g., a selected user, such as the most bullish user, from the market forecast value for an associated enterprise and execute a trade, e.g., buy or sell, based on the bullish user's business forecast value. In an embodiment, the client terminal 120, 130, . . . N and/or the GUI may be configured to rearrange a display of market forecast values and business forecast values from at least two of the plurality of users for the enterprise on the GUI based on accuracy of the business forecast value from the at least two of the plurality of users, e.g., closeness of past business forecast values and an actual performance value of the business performance of the enterprise. In an embodiment, the rearrangement may include positioning the icon or display of the business forecast value most interested by the user closest to the buy button and/or based on an amount of time the user views the other business forecast value(s), e.g., if the user views the most bullish user most often, the most bullish user's business forecast value will be rearranged.

As such, the client terminal 120, 130, . . . N and/or the GUI is configured to visually present the business information and relevant analytics in a quick and easy visualization to make informed and rapid decisions regarding an enterprise or a plurality of enterprises. In an embodiment, when the business information is stored on the NoSQL database, the server may be configured to render and transmit the data for graphical representation of the business information to the at least one client terminal 120, 130, . . . N quickly at least because the NoSQL may include pre-calculated histogram data which speeds up the calculation and transmitting processes via the server 110, e.g., by being stored and/or pre-sorted in bins. It is appreciated, however, that when the user makes specific requests, such as, to change the number of bins in the histogram, or the range of the histogram (to eliminate outliers), the server 110 may be configured to recalculate the business information data (already separated from personal data) to new histogram data.

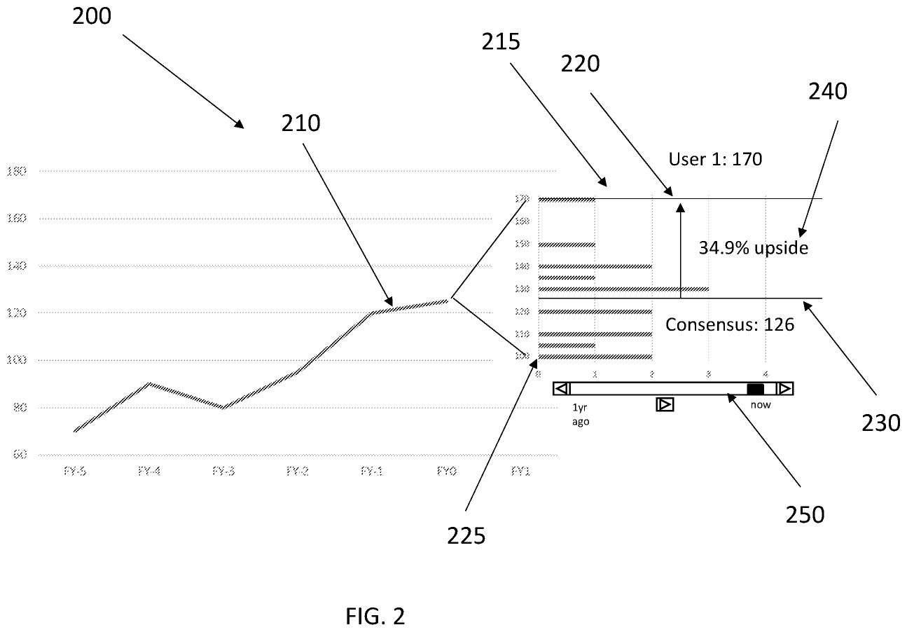

FIGS. 2-6 illustrate various GUIs having graphical representations for presentation of and interaction with the business information on at least one client terminal that is accurate, useful, quick, and/or relevant, e.g., based on user selected parameters.

As seen in FIG. 2, in an embodiment, the client terminal 120, 130, . . . N may be configured such that a GUI 200 provides a graph of the consensus business forecast values 210 for the enterprise for a five-year time frame, e.g., FY-5 to FY-0, along with a histogram 215 for presenting actionable data. The histogram 215 may include indication of the user's business forecast value 220, the range of business forecast values from other users, a visualization of the number of business forecast values for each range, e.g. 225, the consensus business forecast value 230, and the upside and/or downside potential 240 of the user's business forecast value. That is, GUI 200 presents the past consensus business forecast values and the predicted business forecast value for the current/forward year, e.g., FY1, from the user.

As such, in an embodiment, the GUI 200 may be configured to provide information indicating the upside and/or downside potential 240 of the user's business forecast value compared with the consensus business forecast value. For example, as illustrated in FIG. 2, based on the user's business forecast value 220, the GUI 200 may be configured to present a comparison of the user's business forecast value 220, e.g., a value of 170, and the consensus 230, e.g., a value of 126. As such, the GUI 200 may be configured to show and/or calculate the potential upside if the user's business forecast value is correct, e.g., (170/126)−1=34.9% upside to make actionable decisions with respect to the enterprise.

It is appreciated that in an embodiment, since the business information may be stored in bins in the NoSQL, the histogram 215 may be accessed quickly and be computationally efficient, e.g., on the server side. For example, since the business forecast values may be stored in bins in the NoSQL, the amount of entries at specific histogram points are already known and may be accounted for the calculations, e.g., 1 entry at 115, 2 entries each at 110 and 120, etc. As such, when the business forecast value of the user 220 is entered and/or received, the consensus 230 and the upside and/or downside potential 240 may be quickly calculated. The use of the bins may also provide ease of filtering since the number of entries as related to the calculation of the consensus is already known, e.g., if filtering the highest and lowest values, one entry for 150 and one entry for 100 may be removed. Furthermore, it is understood that since the histograms are using anonymous and rounded data generated from the server (e.g., 110) privacy may be maintained while providing market transparency, e.g., since the data are filtered into subsets.

In an embodiment, the GUI 200 may include other icons or buttons that enable quick interaction with the GUI and/or server 110. In an embodiment, the GUI 200 may include a slide bar 250 that allows the viewing of past performance of the consensus, user, or other user business forecast values, buttons or icons for other user selected parameters, including, but not limited to, filtering options based on standard deviations from the consensus, using business forecast values only from users with a predetermined user accuracy level, e.g., greater than 90%, time based filtering, or the like. The GUI 200 may also include the actual business reported values and accuracy of the consensus business forecast value as well as the accuracy of the user, e.g., based on past performance.

It is appreciated that while the user is described, it is understood that any user may be selected for viewing on the GUI. For example, the user's most bullish friend may be selected to see how his/her business forecast values compares to the consensus and if the most bullish friend's business forecast value reaches a predetermined threshold, e.g., greater than 20% of the consensus, an automatic buy signal may be sent to purchase stocks in the enterprise. In an embodiment, the user may also be users selected with a 85% accuracy level or higher, or other user selected parameter.

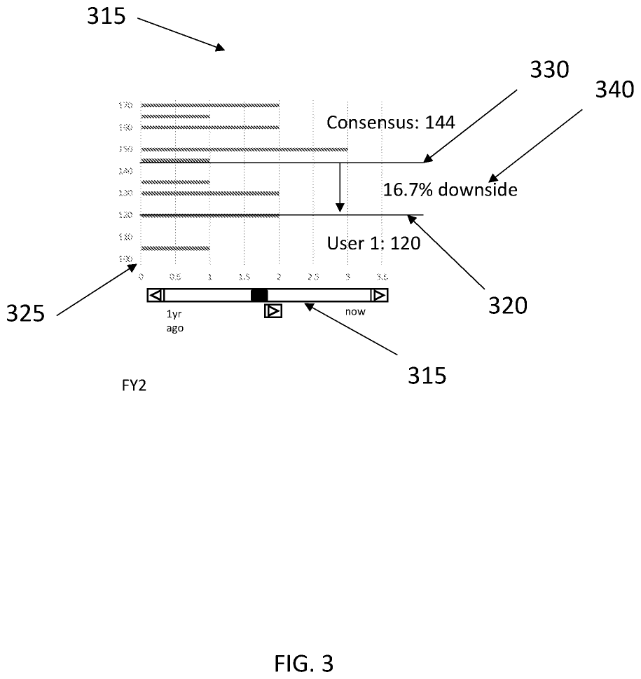

FIG. 3 illustrates a histogram 315 that may be used with a GUI (e.g., 200 of FIG. 2). The histogram 315 may be for a future year FY2, e.g., the next fiscal year, which may change over time. The histogram 315 may include indication of the user's business forecast value 320, the range of business forecast values from other users, a visualization of the number of business forecast values for each range, e.g. 325, the consensus business forecast value 330, and the upside and/or downside potential 340 of the user's business forecast value compared with the consensus business forecast value 330. For example, as illustrated in FIG. 3, based on the user's business forecast value 320, the histogram 315 may be configured to present a comparison of the user's business forecast value 320, e.g., a value of 120, and the consensus 330, e.g., a value of 144. As such, the GUI (e.g., 200) may be configured to show and/or calculate the potential downside if the user's business forecast value is correct, e.g., (120/144)−1=−16.7% downside to make actionable decisions with respect to the enterprise, e.g., sell the enterprise. In an embodiment, since the histogram 315 may be for a future year, the consensus business forecast value, the user business forecast value, and/or the reported business value may alter the histogram 315 data. As such, the visualization of the GUI (e.g., 200) and/or the histogram 315 provides accurate, useful, quick, and/or relevant information for a user to take action that may be automatically set, e.g., when the potential downside in FY2 is lower than 20%, automatically sell the enterprise, e.g., the GUI (e.g., 200) includes buttons to buy or sell the enterprise that is conditional when business forecast values are reached.

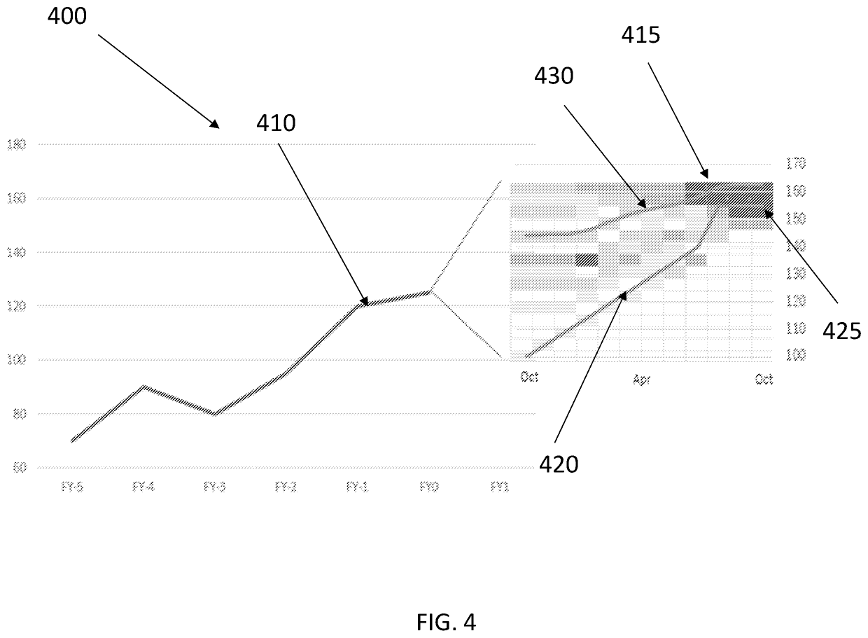

FIG. 4 illustrates an embodiment in which the client terminal 120, 130, . . . N may be configured such that a GUI 400 provides a graph of the consensus business forecast values 410 for the enterprise for a five-year time frame, e.g., FY-5 to FY-0, along with a heatmap 415 for presenting actionable data. The heatmap 415 may include indication of the user's business forecast value 420, the range of business forecast values from other users, a visualization of the magnitude of business forecast values for each range, e.g. 425, and the consensus business forecast value 430. That is, GUI 400 presents the past consensus business forecast values 410 and the predicted business forecast value 420 for the current/forward year, e.g., FY1, from the user and how such values have changed over a predetermined time frame, e.g., one year.

As such, in an embodiment, the GUI 400 may be configured to provide information indicating the similarity of the magnitude of the user's business forecast value compared with other users' business forecast values.

It is appreciated that in an embodiment, since the business information may be stored in bins in the NoSQL, the heatmap 415 may be accessed quickly and be computationally efficient, e.g., on the server side. For example, since the business forecast values may be stored in bins in the NoSQL, the amount of entries at specific heatmap points are already known and may be accounted for the calculations. As such, when the business forecast value of the user 420 is entered, the consensus 430 and the heatmap values 425 may be quickly calculated. The use of the bins may also provide ease of filtering since the number of entries as related to the calculation of the consensus is already known. Furthermore, it is understood that since the heatmaps are using anonymous and rounded data generated from the server (e.g., 110) privacy may be maintained while providing market transparency, e.g., since the data are filtered into subsets.

In an embodiment, the GUI 400 may include other icons or buttons that enable quick interaction with the GUI and/or server 110. In an embodiment, the GUI 400 may include a slide bar that allows the viewing of past performance of the consensus, user, or other user business forecast values, buttons or icons for other user selected parameters, including, but not limited to, filtering options based on standard deviations from the consensus, using business forecast values only from users with a predetermined user accuracy level, e.g., greater than 90%, time based filtering, or the like. The GUI 400 may also include the actual business reported values and accuracy of the consensus business forecast value as well as the accuracy of the user, e.g., based on past performance.

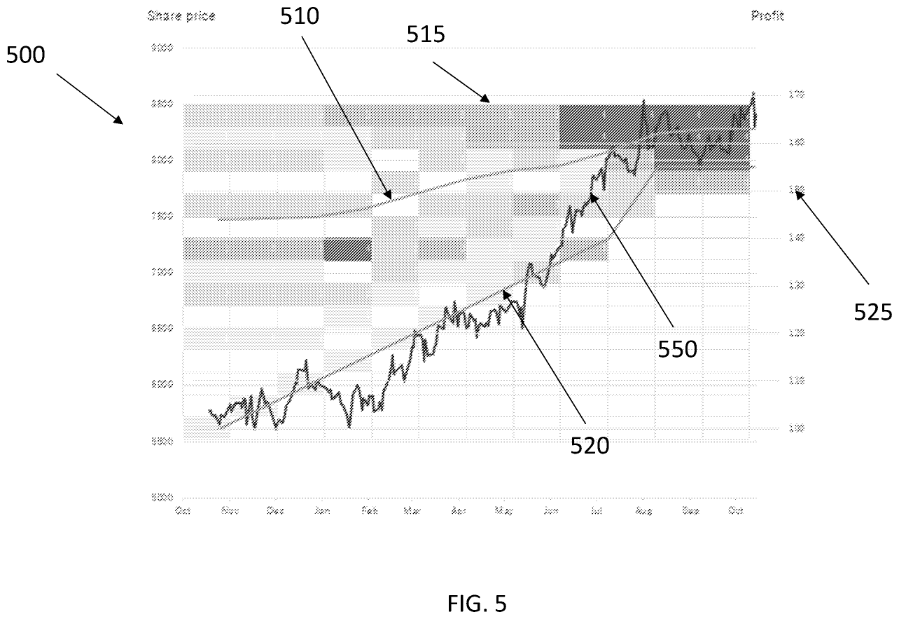

FIG. 5 illustrates an embodiment in which the client terminal 120, 130, . . . N may be configured such that a GUI 500 provides a graph of the consensus business forecast values 510 for the enterprise for a year time frame, e.g., October to October, along with a heatmap 515 and share price for presenting actionable data. The heatmap 515 may include indication of a visualization of the magnitude of business forecast values for each range, e.g. 525, and the consensus business forecast value 510. That is, GUI 500 presents the past consensus business forecast values 510 and the predicted business forecast value 520 for the current/forward time frame, e.g., September to October, from the user and how such values have changed over a predetermined time frame, e.g., one year. As such, a history (progression) of the consensus business forecast value 510 is represented in line graph, whereas the range and distribution per period is represented by the heatmap 515, which is overlayed on top of the historical share price 550.

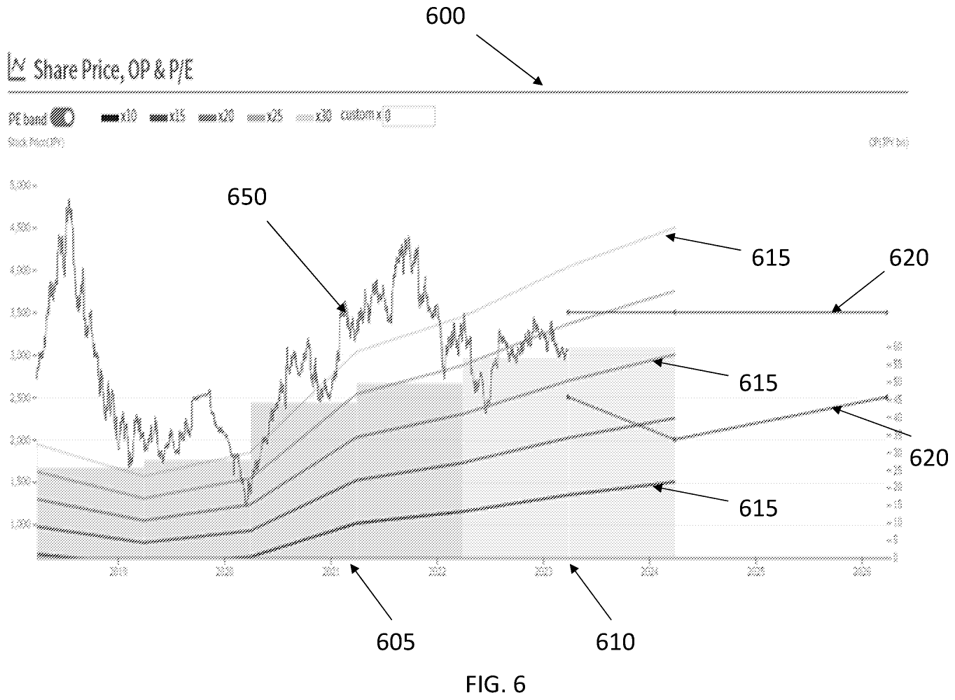

FIG. 6 illustrates an embodiment in which the client terminal 120, 130, . . . N may be configured such that a GUI 600 provides a graph of a Share Price 650 that overlays historical Earnings 605, e.g., actual historical forecast or historical consensus forecast Earnings Before Interest and Taxes (EBIT), consensus EBIT 610, e.g., consensus business forecast values, implied PIE bands 615, which can be switched between actual results, historical forecasts, historical consensus forecasts, etc., and business forecast values 620, e.g., user's upper and lower target prices for presenting actionable data. The Earnings Forecasts 605 and/or 610 may be determined based on one or more of Bloomberg Consensus, user's custom input, the consensus business forecast values 610 for the enterprise, for a predetermined time frame, e.g., quartiles, trailing twelve months or next twelve months. That is, GUI 600 presents the past historical earnings (actual and/or forecasts) 605 and the predicted business forecast value 610 for the current/forward time frame along with P/E bands 615. As such, a history (progression) of the P/E bands 615 along with the actual business forecast value 605 and consensus predicted business forecast value 610. By displaying Share price, earnings, and implied P/E bands, the user can visualize the range of forward-looking Target Prices. P/E bands can be switched to P/B, EV/EBITDA or other valuation multiples. Earnings can be EBIT, Net Income, EBITDA or other profit metrics.

FIG. 7 illustrates a flowchart of a presentation management method 700, in accordance with an example embodiment. The method 700 may be performed by a program, circuitry, or by a combination thereof. For example, the method 700 may be executed by a processing unit, central processing unit, or other processor-enabled device, which may be cloud-based, a local device, or downloaded to the local device. It will be understood by those skilled in the art that each function and/or operation of the components may be implemented, individually and/or collectively, by a wide range of hardware, software, firmware, or any combination thereof.

At 710, the presentation management method is started in which the server (e.g., 110) receives from a plurality of client terminals, a business forecast value for an enterprise from a plurality of users. The business forecast value may be related to the business performance of the enterprise, in which the enterprise may be a business, such as a company, that is listed on public and/or private exchanges. In an embodiment, the business forecast value may be a forecast value related to a forecasted profit of the enterprise including, but not limited to, at least one of revenues, operating profit, earnings before tax, net profit, or earnings per share of the enterprise, or a combination thereof, e.g., includes at least two of the forecast values. In an embodiment, the forecast value related to the continuous profit of the enterprise may be a factor specified in advance by the enterprise or by an industry to which the enterprise belongs. The method may then proceed to 720.

At 720, an integrity of the plurality of users sending the business forecast value from the plurality of client terminals may be validated to ensure the accuracy of the business forecast value. The validating the integrity of the plurality of users may include: tracking the business forecast value from each of the plurality of users for a predetermined period of time, determining the accuracy of the business forecast value from the users, determining a length of time the user has been actively providing business forecast values, verifying a user's company affiliation and/or existence, e.g., verifying that the user has the job indicated on a user profile and/or the company is a real company in existence, verifying that the user is an original and/or single user, e.g., a unique user that does not have multiple accounts, e.g., based on social security numbers, passport numbers, date of births, addresses, or other identifying information, checking the background of the user, e.g., criminal records check based on publicly available data, education, employment, and other activities, or other checks to ensure that the user is not a bad actor, e.g., someone who is just trying to manipulate or game the system. In an embodiment, the server 110 may be configured to only use business forecast values from validated users, e.g., by filtering and only using business forecast values from highly accurate users, e.g., users having an accuracy level above a threshold value, e.g., 85%, 90% or 95%, as compared with a reported business value, and/or from users that have provided business forecast values for a length of time, e.g., 6 months, 1 year, 2 years, 5 years, etc. The server 110 may also be configured to weight the business forecast value based on the integrity of the user, e.g., by a factor of 5 or 10 when calculating the market forecast value. As such, the presentation management system having the server 110 that is configured to validate the integrity of the user may be able to maintain high data integrity of its system by limiting and/or eliminating the bad actors who are attempting to manipulate the system for only their own financial gain, e.g., users who may be inputting inaccurate business forecast values in bad faith, and/or those with relatively inaccurate business forecast values or experience. In an embodiment, the validating the integrity of the user may occur before anonymizing the business forecast value, as discussed further below.

The validating the integrity of the user may further include tracking how and when the user changes any of the business forecast values. As such, not only does the time tracking of the entered business forecast values allow the filtering of old or stale business forecast values, e.g., based on a predetermined time period, e.g., if the business forecast value is more than 1 month old, two months old, four months old, etc., a user's accuracy may be tracked for all business forecast values.

In an embodiment, the accuracy level or the high confidence level of a user may be determined by analyzing a past performance of the user. In an embodiment, the accuracy level or the high confidence level may be determined by taking the delta or difference of the business forecast values between top user business forecasters, e.g., top 90%, and the user, taking the delta of the business forecast values between the consensus and the user, taking a delta or difference of the business forecast value between the user and the reported business value, taking a statistical analysis of the delta of the business forecast value between the top user forecasters and consensus and/or the delta between the user and the consensus, taking an analysis of when the forecast was made by the user, e.g., the user may be very accurate when forecast is made three weeks before actual reporting by the business or enterprise, but relatively inaccurate three months before the reporting of the actual business information, the user inputted (subjective) confidence level, which may be analyzed over time to determine the actual accuracy of the user. In an embodiment, the user's accuracy level for the business forecast values may be tracked for one or more enterprises for any specific periods of time, e.g., over the last month, over the last quarter, over the last year, over the last five years, over the last ten years, etc. as compared with historical data and results of the reported business value of the enterprise, e.g., company guidances and/or reportings.

In an embodiment, the user accuracy level of the business forecast values may be used as a condition for viewing other users' business forecast values, e.g., access rights. For example, users having a user accuracy level of 70% or less may only be able to view other business forecast values from users having the same or lower accuracy score, e.g., 70% or less. Users, however, having a user accuracy of 85% may be able to view other business forecast values from users having the same or lower user accuracy. As such, since a user may only be able to see other users having the same or lower accuracy, such use of accuracy may be a further disincentive for users to purposely input inaccurate forecasts, e.g., bad actors, to provide accurate and validating business forecast values. In an embodiment, the users with relatively accurate forecasts, e.g., greater than 85% accuracy, greater than 90% accuracy, greater than 95% accuracy, may be isolated and/or the user's overall statistics, e.g., accuracy level, may be shared or transmitted. The method may then proceed to 730.

At 730, the business forecast value from each of the plurality of users and the plurality of client terminals may be anonymized and stored, e.g., in memory on the server, e.g., by removing data associated with the business forecast value from the user and/or the client terminal transmitting the associated business forecast value. In an embodiment, the business forecast value may be anonymized by automatically re-assigning the business forecast values from the plurality of users to a random and unique ID associated with a user. That is, in an embodiment, after a user accesses the server, e.g., using a user ID and password, and submits a business forecast value, the business forecast value may be disassociated from the respective user, e.g., log-in information, and/or the client terminal, e.g., IP address or computer address. The business forecast value may then be associated with a separate and unique identification (ID), e.g., scrubs the data such that the data does not provide any identifying information of the user and/or the client terminal, but allows tracking of the same. As such, the business forecast value may be processed while maintaining the anonymity of the user(s). In an embodiment, the processing may include grouping business forecast values from people in the same industry, people from the same company affiliation, accuracy of the business forecast values for the last month, last quarter, last year, or other incremented timeframe, or similar grouping method. As such, while large fund managers do not typically have to disclose when they want to divest in a business, e.g., based on the business forecast value, such anonymity allows the large fund managers to be enticed to send their business forecast value for enterprises to get more accurate market forecast values for the enterprises, as a whole in general, e.g., based on all market participants, while preventing other users from front-running the institutional investment managers or large money managers before their divestiture. The method may then proceed to 740.

At 740, a market forecast value for the enterprise may be calculated and/or updated, in an automated manner, based on a plurality of the stored business forecast values. In an embodiment, the calculating of the market forecast values for enterprises may include taking a consensus (e.g., median or average) of the business forecast values from the plurality of users of the plurality of client terminals. In an embodiment, the calculate and/or update of the market forecast values includes averaging the business forecast value from each of the plurality of client terminals, or taking a mean value of the business forecast value from each of the plurality of client terminals. In an embodiment, the market forecast value may be calculated based on the plurality of business forecast values, for example, an average value and a standard deviation of the plurality of user forecast values, e.g., a difference between the business forecast value transmitted from the plurality of client terminals and an average value of the plurality of the business forecast values. During calculation of the market forecast value, a forecast value of a specific user may be included or excluded.

The calculating the market forecast values may also include only using data from highly accurate users, validated users, users that have used the system for a length of time, e.g., more than 6 months, more than 1 year, more than 2 years, more than 5 years, etc., or other user selected parameters, e.g., a business forecast value from a specific user or group of users, which may be done automatically, e.g., select most bullish friend(s) the user follows. In an embodiment, the calculating the market forecast values may occur when a predetermined number of business forecast values have been received, e.g., if more than 5, 10, 15, 20, or 25 business forecast values are received. In an embodiment, if the predetermined number of forecast values have not been received, the existing values of the market forecast value that have been previously stored on the server 110 may instead be used. The calculating the market forecast value may include rounding each business forecast value based on a certain threshold, sorting the business forecast values to a predetermined number of bins, e.g., data bins, and transmitting the business forecast values from the predetermined bins to at least one client terminal. The bins may be related to the user selected parameters, e.g., grouped based on users belonging to the same industry, on accuracy of the user providing the business forecast values, e.g., all business forecast values from users with 90% accuracy, or the business forecast values may be stored in a database on the server.

In an embodiment, the market forecast value may be updated daily, weekly, monthly, or when a predetermined number of business forecast values have been received and/or based on a user selected time, e.g., past 30 days, past 3 months, past 6 months, past year, or past five years, etc. The business information data and/or market forecast values may be stored for quick access to a separate, NoSQL (non-SQL) or SQL database in which the business information data and/or market forecast values are presorted and/or arranged based on the platform defined subsets and/or user selected parameters. It is appreciated that when the business information data is stored on the NoSQL database, the speed may be increased, while still maintaining data integrity and security.

In an embodiment, the business information data and/or market forecast values may be stored periodically, e.g., every hour, every day, every week, every month, etc. The stored data may also include: 1) Time to indicate a point in time associated with the data; 2) Calculated consensus; 3) Histogram range of the business forecast values (example: max 170, min 100); 4) Histogram data (number of data in each histogram bin); 5) Each and all forecast data of a specific company at a specific time that is used for the Histogram data. The method may then proceed to 750.

At 750, a request from at least one client terminal may be received to access any of the above business data, including the market forecast value. After the client terminal has been verified as to whether the client terminal has access rights to the business information data, e.g., the at least one client terminal may only have access rights from a specific point in time, e.g., past six months, in which case, only data from that specific time is sent (example: user joined network recently and do not have access rights to historical forecasts) or the at least one client terminal may not have access rights to the business information data if the number of user entries does not exceed a threshold, e.g., more than 5 entries, more than 10 entries, more than 20 entries, more than 50 entries, etc., the business data may be sent, which the at least one client terminal has access to, to the at least one client terminal. In an embodiment, the user of the at least one client terminal's historical actuals and forecasts may also be sent to the at least one client terminal. It is appreciated that since the business data is stored in bins, no personal data is made available to identify the user and associated business forecast value.

In an embodiment, the request from at least one client terminal to receive the market forecast value may include user selected parameters, which may include selecting a specific user, for example, based on being the most bullish friend, user accuracy level, user accuracy level based on a certain time frame, e.g., 85% or 90% accuracy in the last six months, etc. In an embodiment, the users may be categorized as being “friends,” e.g., previous connection between users, being within the same user accuracy group, being within the same industry, etc. The method may then proceed to 760.

At 760, after the access rights of the client terminal and/or user has been verified, the market forecast value may be transmitted for displaying on the at least one client terminal. The method may then proceed to 770.

At 770, the transmitted market forecast value may be displayed on the at least one client terminal.

It is also to be understood that the processing flow 700 may include one or more operations, actions, or functions as illustrated by one or more of blocks 710-770. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation.

In an embodiment, the method 700 may further include determining a deviation value of the business forecast value transmitted from at least one client terminals with respect to the market forecast value. The deviation value is, for example, a difference between the business forecast value from the user and the average value, e.g., the consensus value. The method may further include, when the deviation value is equal to or greater than a predetermined value, an alert is transmitted to the at least one client terminal. The predetermined value may be one or two times of the standard deviation, or may be a predetermined ratio (for example, 10% or 15%) with respect to the consensus value. When there is a large change in one time business performance of an enterprise, for example, as for an enterprise whose annual operating profit is typically around 10 billion yen, in a case where an operating profit in the last year is 1 billion yen due to a one time factor, a business performance forecast of the next year may vary greatly. In such a case, normalization or adjustment may be made.

The method 700 may also include a step in which the alert may be transmitted only when past performance of the user is equal to or greater than a certain level, for example, when a difference between a past business forecast value and an actual performance value of the business performance of the enterprise is within a predetermined range, e.g., the reported business value. The predetermined range may include, for example, a case where past business forecast values of respective users with respect to the enterprise are ranked in an order of closeness to the actual reported business value, and the business forecast value is ranked at a high position. In a case where there are business forecast values and actual reported business values of a plurality of years, more recent ranks may be weighted and averaged, or ranks in years when the business performance variation is larger may be weighted and averaged. The averaged ranks may be expressed in quartiles or quintiles.

The method 700 may also include transmitting the alert only when confidence in the business forecast value is high. The alert may indicate that there is a certain amount of deviation between a user's business forecast value and the market forecast value related to the enterprise' business performance forecast of the enterprise. This suggests that the market could be surprised if the user's forecast is correct, and the user can expect the stock price to move significantly. The alert may be considered, for example, as a “securities to watch” or a “securities recommended to buy/sell (trade)” or a condition to buy or sell, e.g., automatically trigger the action.

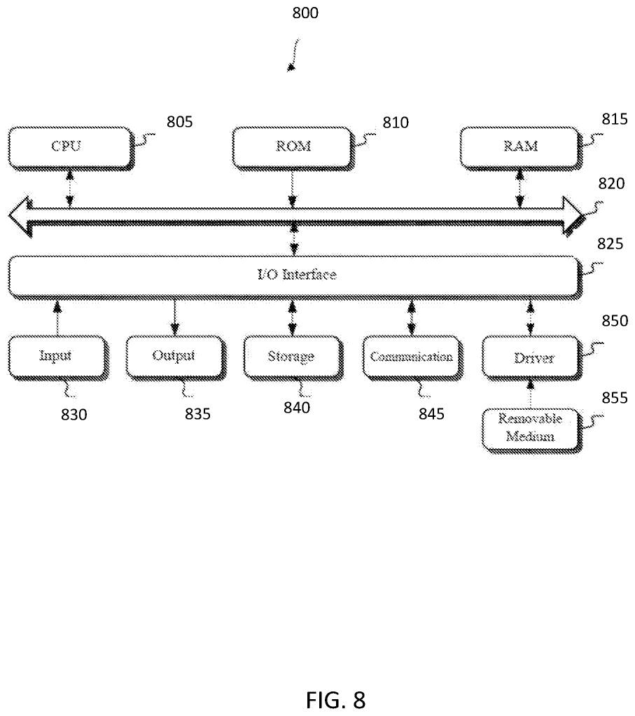

FIG. 8 is a schematic structural diagram of an example computer system 800 applicable to implementing an electronic device (for example, a GPU or CPU), arranged in accordance with at least some embodiments described herein. It is to be understood that the computer system shown in FIG. 8 is provided for illustration only instead of limiting the functions and applications of the embodiments described herein.

As depicted, the computer system 800 may include a central processing unit (CPU) 805. The CPU 805 may perform various operations and processing based on programs stored in a read-only memory (ROM) 810 or programs loaded from a storage device 840 to a random-access memory (RAM) 815. The RAM 815 may also store various data and programs required for operations of the system 800. The CPU 805, the ROM 810, and the RAM 815 may be connected to each other via a bus 820. An input/output (I/O) interface 825 may also be connected to the bus 820.

The components connected to the I/O interface 825 may further include an input device 830 including a keyboard, a mouse, a digital pen, a drawing pad, or the like; an output device 835 including a display such as a liquid crystal display (LCD), a speaker, or the like; a storage device 840 including a hard disk or the like; and a communication device 845 including a network interface card such as a LAN card, a modem, or the like. The communication device 845 may perform communication processing via a network such as the Internet, a WAN, a LAN, a LIN, a cloud, etc. In an embodiment, a driver 850 may also be connected to the I/O interface 825. A removable medium 855 such as a magnetic disk, an optical disk, a magneto-optical disk, a semiconductor memory, or the like may be mounted on the driver 850 as desired, such that a computer program read from the removable medium 855 may be installed in the storage device 840.

In the above embodiment, the market forecast value can be updated periodically or irregularly. For example, latest forecast values of all users who have made forecasts of a specific enterprise for a specific accounting period may be collected, and an average and a standard deviation of the forecast values of all the users excluding a forecast value of oneself may be calculated, and each user may be notified of whether a difference between an updated market forecast value and the forecast of oneself becomes smaller or larger than previous calculation.

The present technology can make it easy to share and manage business performance forecasts of an enterprise by a plurality of users, and enable a stock investment recommendation that respects business performance forecasts of each user, including retail investors and small scale investors. In addition, it is possible to grasp latest market forecast values without waiting for updates from analysts in securities brokers, research companies, and the like, which may take a long time to go through their internal processes. For example, the present invention can be applied to support those making business performance forecasts, such as retail investors or institutional investors, with their investment decisions.

It is to be understood that the disclosed and other solutions, examples, embodiments, modules and the functional operations described in this document may be implemented in digital electronic circuitry, or in computer software, firmware, or hardware, including the structures disclosed in this document and their structural equivalents, or in combinations of one or more of them. The disclosed and other embodiments, including the means for implementations, may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this document may be performed by one or more programmable processors executing one or more computer programs to perform functions by operating on input data and generating output. The processes and logic flows may also be performed by, and apparatus may also be implemented as, special purpose logic circuitry, e.g., a field programmable gate array, an application specific integrated circuit, or the like.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; and magneto optical disks. The processor and the memory may be supplemented by, or incorporated in, special purpose logic circuitry.

It is to be understood that different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

1. A presentation management system configured to present business performance information of an enterprise on at least one client terminal, the presentation management system comprising:
a server, which includes a processor and a memory,
wherein the server is configured to:
receive from a plurality of client terminals a business forecast value for the enterprise from a plurality of users,
validate an integrity of the plurality of users sending the business forecast value from the plurality of client terminals,
anonymize the business forecast value from each of the plurality of users and the plurality of client terminals transmitting the associated business forecast value and store, in the memory, the anonymized business forecast value,
calculate and/or update, in an automated manner, a market forecast value for the enterprise based on a plurality of the stored business forecast values,
transmit an alert message to the at least one client terminal, wherein the alert message indicates that a deviation value with regard to a business forecast value from the at least one client terminal from the market forecast value is greater than a predetermined value, or
receive a request from the at least one client terminal to receive the market forecast value, and
transmit the market forecast value for displaying on the at least one client terminal,
wherein the server is configured to calculate and/or update and transmit the calculated market forecast value based on user selected parameters received from the at least one client terminal.

2. The presentation management system according to claim 1, further comprising the plurality of client terminals, wherein each of the plurality of client terminals comprises a graphic user interface (GUI), and the at least one client terminal of the plurality of client terminals is configured to:
rearrange a display of market forecast values for a plurality of enterprises on the GUI of the at least one client terminal based on a magnitude of a deviation value of the business forecast value from a user from the market forecast value for an associated enterprise.

3. The presentation management system according to claim 1, wherein the validate the integrity of the user includes at least one of:
tracking the business forecast value from each of the plurality of users for a predetermined period of time,
verifying a company affiliation and/or a company existence for each of the plurality of users,
verifying that each the plurality of users is a unique user,
validating an IP address of each of the plurality of client terminals for each of the plurality of users, or
checking a background of each of the plurality of users.

4. The presentation management system according to claim 1, further comprising the plurality of client terminals, wherein each of the plurality of client terminals comprises a graphic user interface (GUI), and the at least one client terminal of the plurality of client terminals is configured to:
rearrange a display of market forecast values and business forecast values from at least two of the plurality of users for the enterprise on the GUI based on accuracy of the business forecast value from the at least two of the plurality of users.

5. The presentation management system according to claim 1, wherein the server is further configured to update the market forecast value by at least one of:
removing stored business forecast values that have not been updated for a predetermined amount of time, or
using the stored business forecast values from the plurality of users having an accuracy level above a threshold value.

6. The presentation management system according to claim 1, wherein the calculate and/or update of the market forecast value includes:
weighting the plurality of stored business forecast values based on a length of time a user of the plurality of users has provided the business forecast value.

7. The presentation management system according to claim 1, wherein the server is further configured to verify that a user of the at least one client terminal has access rights to the market forecast value.

8. The presentation management system according to claim 7, wherein the verification that the use of the at least one client terminal has the access rights includes at least one of:
determining whether the user of the at least one client terminal has access rights from a specific point in time,
determining whether a predetermined number of business forecast values have been received, or
determining whether the user meets a predetermined threshold of accuracy level of business forecast values.

9. The presentation management system according to claim 1, wherein at least one of the plurality of client terminals is configured to send business forecast values forecasted by a group of users of the plurality of users as a batch of business forecast values to the server.

10. The presentation management system according to claim 1, wherein the server is further configured to:
filter users of the plurality of users that have an accuracy level above a threshold value for the business forecast value as compared with a reported business value, and/or
transmit statistics of the users of the plurality of users with the accuracy level above the threshold value to the at least one client terminal.

11. The presentation management system according to claim 1, wherein the business forecast value includes a forecast value related to a profit of the enterprise, wherein the forecast value related to the profit of the enterprise includes at least one of revenues, operating profit, earnings before tax, net profit, or earnings per share of the enterprise.

12. The presentation management system according to claim 11, wherein the business forecast value is calculated based on at least two of the revenues, the operating profit, the earnings before tax, the net profit, or the earnings per share of the enterprise.

13. The presentation management system according to claim 1, wherein the calculate and/or update of the market forecast value includes at least one of:
averaging the business forecast value from each of the plurality of client terminals, or
taking a median value of the business forecast value from each of the plurality of client terminals.

14. The presentation management system according to claim 13, wherein the averaging and/or the taking the median value only includes using business forecast values that are within a standard deviation value of a plurality of business forecast values,
wherein the standard deviation value is a difference between the business forecast value transmitted from the plurality of client terminals and an average value of the plurality of the business forecast values.

15. The presentation management system according to claim 1, wherein the presentation management system is configured to change load factors when processing business information data.

16. A presentation management method, the presentation management method comprising:
receiving on a server, from a plurality of client terminals, a business forecast value for an enterprise from a plurality of users;
validating, on the server, an integrity of the plurality of users sending the business forecast value from the plurality of client terminals;
anonymizing, by the server, the business forecast value from each of the plurality of users and the plurality of client terminals transmitting the associated business forecast value and storing, in memory on the server, the anonymized business forecast value;
calculating and/or updating, in an automated manner on the server, a market forecast value for the enterprise based on a plurality of the stored business forecast values;
transmitting an alert message to at least one client terminal, wherein the alert message indicates that a deviation value with regard to a business forecast value from the at least one client terminal from the market forecast value is greater than a predetermined value;
receiving a request from at least one client terminal to receive the market forecast value;
transmitting the market forecast value for displaying on the at least one client terminal; and
displaying on the at least one client terminal the transmitted market forecast value,
wherein the calculating and/or updating and the displaying of the market forecast value include adjusting and/or displaying the calculated market forecast value based on user selected parameters received from the at least one client terminal.

17. The presentation management method of claim 16, further comprising:
rearranging a display of market forecast values for a plurality of enterprises on a GUI of the at least one client terminal based on a magnitude of a deviation value of the business forecast value from a user of the at least one client terminal from the market forecast value for an associated enterprise.

18. The presentation management method of claim 16, wherein validating the integrity of the plurality of users includes at least one of:
tracking the business forecast value from each of the plurality of users for a predetermined period of time,
verifying a company affiliation and/or a company existence for each of the plurality of users,
verifying that each the plurality of users is a unique user,
validating an IP address of each of the plurality of client terminals for each of the plurality of users, or
checking a background of each of the plurality of users.

19. A presentation management system for presenting business performance information of an enterprise on at least one client terminal, the presentation management system comprising:
a means for receiving, from a plurality of client terminals, a business forecast value for the enterprise from a plurality of users;
a means for validating an integrity of the plurality of users sending the business forecast value from the plurality of client terminals;
a means for anonymizing the business forecast value from each of the plurality of users and the plurality of client terminals transmitting the associated business forecast value and a means for storing the anonymized business forecast value;
a means for calculating and/or updating, in an automated manner, a market forecast value for the enterprise based on a plurality of the stored business forecast values;
a means for transmitting an alert message to the at least one client terminal, wherein the alert message indicates that a deviation value with regard to a business forecast value from the at least one client terminal from the market forecast value is greater than a predetermined value;
a means for receiving a request from the at least one client terminal to receive the market forecast value;
a means for transmitting the market forecast value for displaying on the at least one client terminal; and
a means for displaying the transmitted market forecast value,
wherein the means for calculating and/or updating and the means for displaying the market forecast value are configured to adjust the market forecast value based on user selected parameters received from the at least one client terminal.
